(19) United States
(12) Patent Application Publication
(10) Pub. No.: US 2014/0229347 A1
(43) Pub. Date: Aug. 14, 2014

(54) METHOD AND SYSTEM FOR SHARING INFORMATION BETWEEN A PLURALITY OF USERS IN A SOCIAL NETWORKING SERVICE

(71) Applicant: Jawe Chan, Pleasanton, CA (US)

(72) Inventor: Jawe Chan, Pleasanton, CA (US)

(21) Appl. No.: 13/783,255

(22) Filed: Mar. 2, 2013

Related U.S. Application Data
(63) Continuation-in-part of application No. 13/475,475, filed on May 18, 2012.

(51) Int. Cl. H04L 12/18; G06Q 50/00; G06Q 20/14

(52) U.S. Cl. CPC H04L 12/1813; G06Q 20/145; G06Q 50/01
USPC 705/34; 709/204

(57) ABSTRACT

A computer implemented method, system and computer readable storage medium of sharing information between a plurality of users participating in a social networking service is disclosed. Each of the plurality of users has a computer embedded object. The method, system and storage medium comprising receiving information relating to the computer embedded object of a first user of the plurality of users and sending the information of the computer embedded object to a second user for display.

### CROSS-REFERENCE TO RELATED APPLICATIONS; PRIORITY CLAIM

This Non-Provisional patent application claims benefit of U.S. Provisional Patent Application No. 61/487,288 filed May 18, 2011; U.S. Provisional Patent Application No. 61/521,762, filed Aug. 10, 2011; U.S. Provisional Patent Application No. 61/536,059, filed Sep. 19, 2011; U.S. Provisional Patent Application No. 61/536,059 filed Nov. 5, 2011; U.S. Provisional Patent Application No. 61/600,967, filed Feb. 20, 2012; the entire contents of each is hereby incorporated by reference as if fully set forth herein, under 35 U.S.C. §119(e).

### FIELD OF THE INVENTION

The present invention relates generally to social networking and more particularly to of sharing information between a plurality of users in a social networking service.

### BACKGROUND OF THE INVENTION

The Internet is a revolutionary technology for sharing information between users. A user can access information around the world with a simple click of a mouse button. In light of society's popular acceptance of the Internet, the amount of information accessible via the Internet has been growing exponentially. Social networking services such as Facebook, LinkedIn and the like have become available that allow users to communicate information with a plurality of other users about their interests and preferences. For example, a user of such a service can communicate with other users about his/her preferences related to a variety of matters. The information can then be utilized for other purposes. What is desired is improved methods for the use of such information.

### SUMMARY OF THE INVENTION

A computer implemented method, system and computer readable storage medium for sharing information between a plurality of users participating in a social networking service is disclosed. Each of the plurality of users has at least one computer embedded object or device. The method, system and storage medium comprises receiving information relating to the computer embedded object or device of a first user of the plurality of users and sending the information of the computer embedded object or device to a second user for display.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a block diagram of a server that stores and retrieves object data, according to possible embodiments of the present invention;

FIG. 2 illustrates an example of computers communicating with a server, according to a possible embodiment of the present invention;

FIG. 3 illustrates an example block diagram of a computer system, according to a possible embodiment of the present invention;

FIG. 4 illustrates an example of a hardware platform on which a computer or a computing device as described herein may be implemented, according to a possible embodiment of the present invention;

FIG. 5 illustrates an example of flow chart for sharing information between users participating in a social networking in accordance with the present invention.

FIG. 6 illustrates an example of computer networking connection in accordance with the present invention.

FIG. 7 illustrates an example of a user devices profile list.

FIG. 8 is an example of Information Display to user two from the user one device profile list or from user one's computer embedded objects profile list.

### DETAILED DESCRIPTION

The present invention relates generally to social networking and more particularly to of sharing information between a plurality of users participating in a social networking service. In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

1. GENERAL OVERVIEW

2. SOCIAL NETWORKING SERVICES

3. EXAMPLE EMBODIMENTS

4. MORE EXAMPLES OF POSSIBLE EMBODIMENTS

5. EQUIVALENTS, EXTENSIONS, ALTERNATIVES AND MISCELLANEOUS

### 1. General Overview

This overview presents a basic description of some aspects of a possible embodiment of the present invention. It should be noted that this overview is not an extensive or exhaustive summary of aspects of the possible embodiment. Moreover, it should be noted that this overview is not intended to be understood as identifying any particularly significant aspects or elements of the possible embodiment, nor as delineating any scope of the possible embodiment in particular, nor the invention in general. This overview merely presents some concepts that relate to the example possible embodiment in a condensed and simplified format, and should be understood as merely a conceptual prelude to a more detailed description of example possible embodiments that follows below.

In a possible embodiment, a system and method for sharing information in a social networking environment relating to an object is provided. An object may be found through a specification searching criteria derived from a specification or/and identification code of a computer that the user is associated with. The specification or identification code of the associated computer may be stored in a RAM, ROM, or Flash Memory and it may be delivered to the user computer through a network connection. In a possible embodiment, the associated computer may be connected to the user computer by one of the following connection methods: Ethernet connection, ASDL connection, wireless connection, USB connection, fiber optic connection, network connection, power line network connection, modem connection. The associated computer may connected to (the identification codes of the computers may be saved in a memory or storage device of the user computer or server) is currently connected to the user computer.

In a possible embodiment, the user computer mentioned in this invention may mean the user computer embedded object. The user computer embedded object or the user computer may be, but not limit to, a laptop computer, a mobile device, a smart phone, a vehicle with an embedded computer, an ebook, a computer tablet, a network connected TV.

In a possible embodiment, the specification identification code configuration of the computer embedded object may be accessed by the user computer with the hostname of the computer embedded object; wherein a hostname is a label that is assigned to a computer embedded object connected to a computer network and that is used to identify the computer embedded object in various forms of electronic communication. The user ID and password may be needed, along with the hostname of the computer embedded object, in order to gain access to the specification or identification code, or configuration of the computer embedded object. In one possible embodiment, the specification or identification code or configuration of the computer embedded object may be stored in a flash memory or disk drive. In a possible embodiment, the hostname of the computer embedded object is the hostname of the associated computer.

The object can be a mobile device, a computer embedded object, a vehicle, an accessory for a mobile device, a mobile subscription plan, a promotion or coupon information regarding service or merchandise, or anything related to the computer that the user computer receives from a network connection. The identification code can be used to identify the associated computer and its specification, e.g., a hardware description, such as: microprocessor, memory size/type, display screen type/resolution, whether the display screen is monochrome or color, color bit depth, keyboard specification, communication connection number/type, etc.; or software description, such as: operating system, applications native/added, etc. The identification code is selected from at least one of the group consisting of: string of codes, IP (Internet Protocol) address, MAC (Media Access Control) address, host name, IMSI (International Mobile Subscriber Identity), TMSI (Temporary Mobile Subscriber Identity), IMEI (International Mobile Equipment Identity), TAC (Type Allocation Code), MEDI (Mobile Equipment Identifier), string of ASCII characters, serial number, FCC ID, model number, etc. The accessed information can be merchandise information specified by the user or advertisement information displayed to the user via a service provider.

### Example of System Architecture

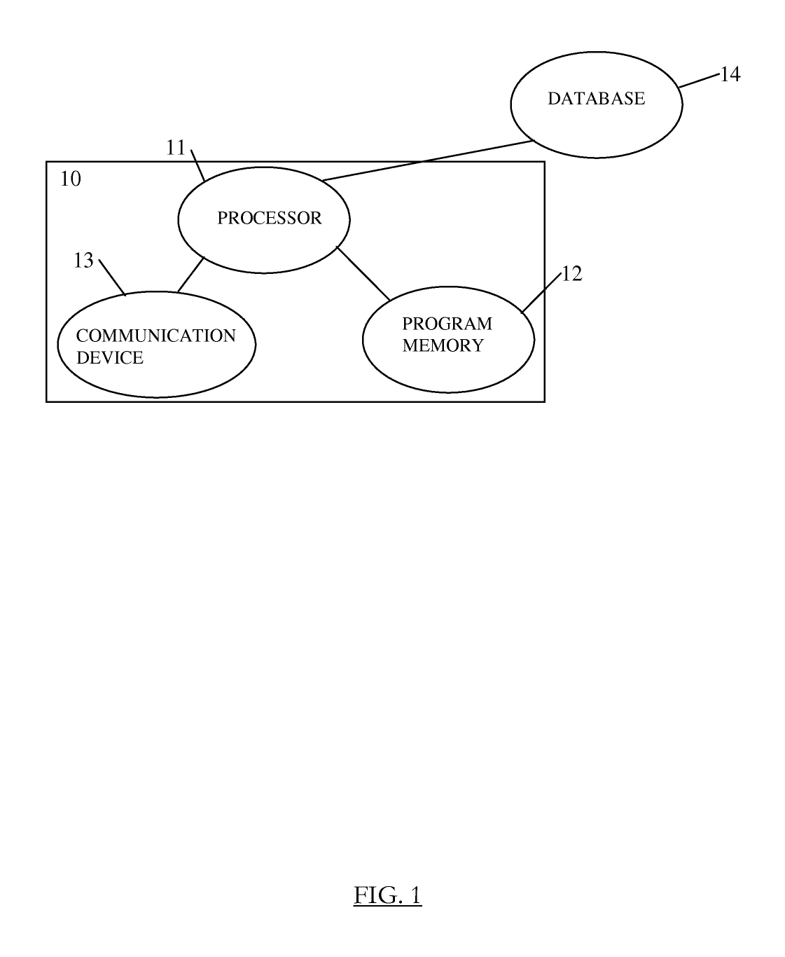

FIG. 1 illustrates a block diagram of a server 10 that stores and retrieves object data. Server 10 can include a processor 11, program memory 12, a communication device 13, and a database for objects 14. The communication device 14 may be a modem or a high-speed leased line router. In a possible embodiment, server 10 is an information server and processor 11 is in data communication with various end-user computer systems via the Internet. However, in other possible embodiments, the server 10 could be implemented with a processor 11 having multiple modems to receive calls directly from end-user computer systems and establishing data communication via the modems and public phone lines, e.g., POTS. The database 14 may include the promotion information for objects that includes, but is not limited to: e-coupons, coupons or product sales events, price of an object, an identification of an object, etc.

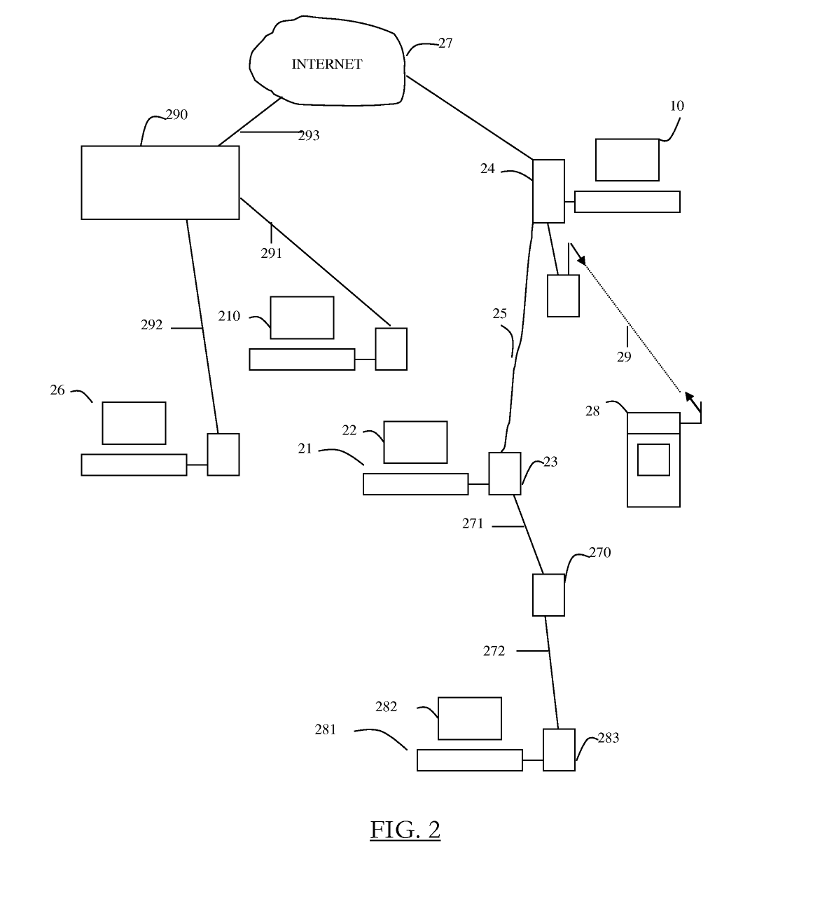

An example of a server 10 is a system operating in accordance with the Sun MicroSystems Solaris operating system, Linux, Microsoft Windows Server, etc. Processor 11 may be any general-purpose processor having a CPU, RAM, ROM, and I/O circuitry. Referring to FIG. 2, end-user computers 21, 26, and 28 communicate with the server 10 in a variety of ways. In a possible embodiment, end-user computer 26 is associated with a computer 210 through a computer network box 290. Box 290 may be a router with DSL Modem. Connection 291 may be the network connection from end-computer 26 to a computer network router with DSL modem. Connection 292 may be the network connection from an end-user associated computer 210 to a network router with DSL modem 290. End-user computer 26 may be able to access identification code or specification of the associated computer 210 through network connection 291, 292 and network router 290. In a further possible embodiment end-user computer system 26 is also connected to server 10 through Internet 27. The sharing criteria of the end-user at computer 26 may be derived from the identification code and specification of the associated computer 210. In a possible embodiment, end-user computer system 21 connects to server 10 via modem 23 and modem 24 through phone line 25. In a possible embodiment, end-user computer 21 can be communicatively connected to a display device 22. In another possible embodiment, display device 22 may be incorporated within end-user computer 21. The end-user computer 21 may be associated with a computer 281 through network connections 271, 272 and network router 270. End-user computer 21 may be able to access identification code or specification of the associated computer 281 through network connections 271, 272 and network router 270. In a further possible embodiment end-user computer system 21 is also connected to server 10 through connection 25. In a further possible embodiment, end-user computer system 28 connects to server 10 through radio frequency link 29. The end-user computer 28 is associated with a computer 210 through internet 27. End-user computer 28 may be able to access identification code or specification of the associated computer 210 through network connections 29, 291, 293, network router 290, and Internet 27. In a possible embodiment, computer ID includes a string of codes. Computer ID could also, or alternatively, include any of: an Internet Protocol (IP) address, a Media Access Control (MAC) address, a host name, an International Mobile Subscriber Identity (IMSI), a Temporary Mobile Subscriber Identity (TMSI), an International Mobile Equipment Identity (IMEI), or a Mobile Equipment Identifier (MEID), a TAC (Type Allocation Code), a string of ASCII characters, a serial number, an FCC ID, and a model number.

In a possible embodiment, object specification includes, but is not limited to, one or more of the following: operating system, processor speed, memory size, memory type, dimension, weight, color, style of the object, type of the object, subscription plan, network connection speed, network connection type, display technology, display size, display resolution, software revision, coverage availability, type of battery, camera resolution quality, ability to be customized, type of keyboard, or GPS availability.

The following is an example of an object specification, where the object is a mobile device:

a. Type of Phone: flip phone, back flip.

b. Operating System: Any operating system for Mobile Phone 2.1.

c. Processor: XYZ Brand 1 GHz mobile processor.

d. Internal Memory: ROM 1 GB; RAM 576 MB.

e. Compatibility: WiFi: 802.11b/g * GPS/AGPS.

f. Email: One Exchange, up to 7 POP/IMAP.

g. Dimensions: 123×68×10 mm.

h. Weight: 157 g (with battery).

i. Display: 4.3-inch HD touch-sensitive screen with 480×800 WVGA resolution.

j. Technology: GSM: 850/900/1800/1900 MHz WCDMA/HSPA: 1700 MHz (AWS)/2100 MHz.

In this example, the type of phone can include, but is not limited to, any of: flip phone, back flip, candy bar, smart phone, sliding keyboard, soft keyboard, etc. The operating system can include, but is not limited to, any of: Any operating system for Mobile Phone 2.1, IOS 4, Windows CE, Windows Phone, Android, etc.

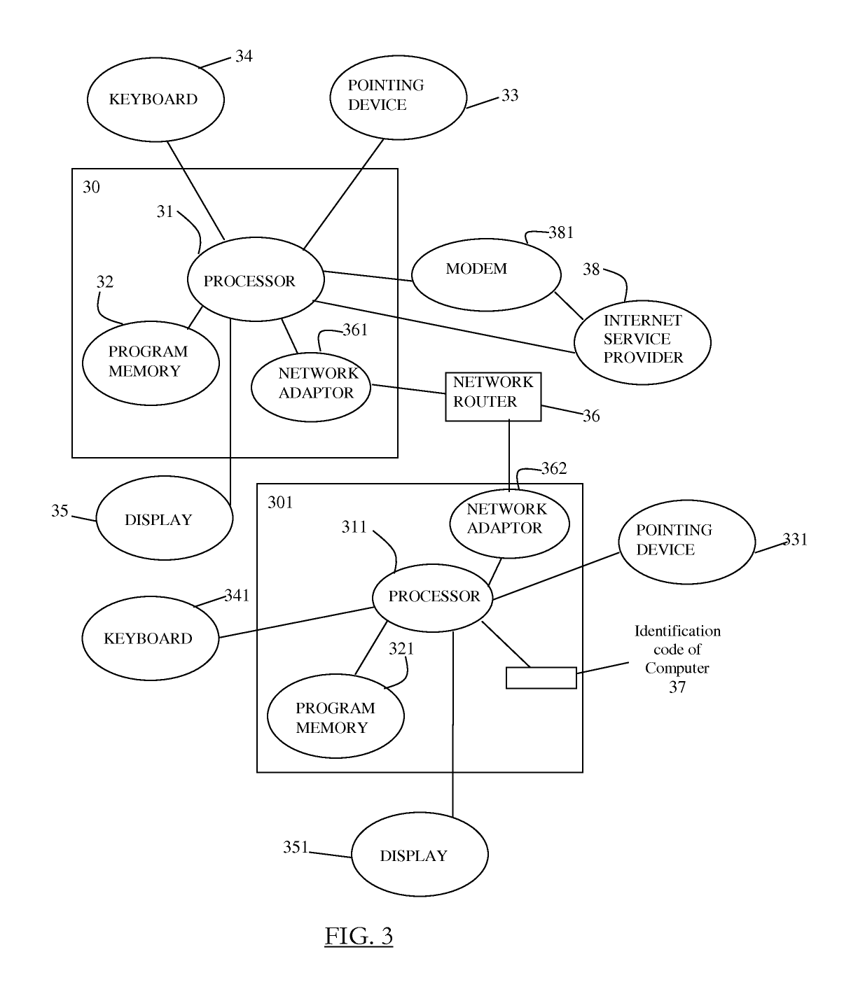

Referring to FIG. 3, a block diagram of an example associated computer system 301 that is associated with end-user computer system 30 is shown. Computer system 30 comprises a processor 31, program memory 32, a mouse 33 and keyboard 34 for user input, a display 35, a network adaptor 361, a modem 381 and a network router 36. Associated computer system 301 comprises a processor 311, program memory 321, a mouse 331 and keyboard 341, a display 351, a network adaptor 362, and identification code of the associated computer system 37. A connection from computer system 30 to an Internet Service Provider (ISP) 38 is also shown. The connection may be via broadband, wired, wireless, satellite, POTS, DSL, ADSL, etc. A connection through network router 36 from computer system 30 to the associated computer system 301 is also shown. In the environment of FIG. 2, system 30 is an end-user computer system, and processor 31 is in data communication with an Internet Service Provider 38. The Internet Service Provider 38 transmits the data to the server 10 via the Internet. In other possible embodiments, the system could be implemented with a processor 31 having a modem 381 calling directly to the server 10 and establishing the data communication link via the modem 381. Alternatively, the system could be implemented such that the end-user computer system 30 and server 10 are connected via a local network.

In a possible embodiment, the network includes a data network based on an internet protocol (IP). In another possible embodiment, the network includes a wired local area network (LAN) such as an Ethernet LAN. In one embodiment, the network includes a wireless local area network (WLAN). In yet another possible embodiment, the network includes a wide area network (WAN). In another possible embodiment, the network includes a public data network, such as a WiFi hotspot network, or a cellular data network such as General Packet Radio Service (GPRS) network. In a possible embodiment, the network includes a private data network such as a home network, a corporate network, a regional corporate network or a corporate Virtual Private Network (VPN). In another possible embodiment, the network includes a service provider network.

The ID code of associated computer 37 is resident in the hardware of associated computer 301. End-user computer system 30 can send the associated computer ID 37 to server 10. Alternatively, the end-user of end-user computer system 30 can input the ID code from another input device, for example from a keyboard 34, if the user knows the computer ID of the associated computer 301 or would like to search for object information using another computer ID.

An example of a suitable end-user computer system 30 or associated computer system 301 is one operating in accordance with the Microsoft operating system, Apple Mac OS, Linux, etc. Processor 31 or 311 may be any general-purpose processor having a CPU, RAM, ROM, and I/O circuitry. Other input devices instead of, or in addition to, mouse 33 and keyboard 34 could be used, such as trackballs, touch pads, graphic tablet, or joysticks. The processor 31 is programmed to execute a process to help the user and accept and process the user's input.

### 2. Social Networking Services

Social networking is becoming popular as a way to communicate information between linked users. Examples of social networking services are LinkedIn, Facebook, Google plus. These types of services allow a user to communicate with other linked users for a variety of reasons. A system and method in accordance with an embodiment can be utilized advantageously to provide enhanced value for such a communication. This can be accomplished through the sharing of identification information, specification, or make and model of a computer embedded object such as a smartphone, laptop, tablet or other type of electronic device.

The sharing of identification information can be accomplished in a variety of ways. For example, a database can be constructed utilizing the identification information of the computer embedded objects of the plurality of users on the social networking service. For example, the identification information of the computer embedded object may be IMEI of the computer embedded object. In addition, the user identification of each of the plurality of users of the social networking may also be within the database. In one embodiment, an operator of the social networking service may access the information related to the computer embedded object of each user in the network. Such information may be located in a centralized database. In another embodiment, the information may be located in a distributed database wherein a portion of the information is stored within the computer embedded object of each user.

### Database

A database for the social networking service may be built from the plurality of computer embedded objects to enhance the utility of the present invention in social networking environment. The database preferably can be queried by a user or a service provider. For example, a mobile handset manufacturer may be able to access the database to obtain the correlation information between mobile handset model and viewing statistics of a text message. For example, the correlation can between the model number of the mobile handset and the length of the text message. One of ordinary skill in the art recognizes many types of correlation that could be provided and they would be within the spirit and scope of the present invention.

In an embodiment, a method and system for collecting data of a plurality of users participating in a social networking service is disclosed. The method and system includes a server, such as the before described server 10. Each of the plurality of users has a computer embedded object. In an embodiment, a database is built within the server 10 utilizing information from the computer embedded objects. The database can query the embedded objects in a predetermined to obtain information related to the embedded objects. For example, if information is missing from the database, the database can query the computer embedded objects on a periodic basis to obtain the missing information. In another example data mining techniques can be utilized by the server 10 to examine the database. In yet another example, data management systems can be utilized by the server 10 to examine the database.

Accordingly, in a first aspect a computer implemented method or system for use with a social networking service includes receiving information relating to the computer embedded object of a first user of the social networking service; and sending the information of the computer embedded object to a second user for display. In so doing information about the computer embedded object of the first user is available to the second user.

In another aspect, comment information related to an identification code of the first user can be received by the other users linked to the first user. The comment information comprises, for example, any or any combination of information about the usage experience of the first user, a log file of the computer embedded object, a tweet, is located in a fan page.

In yet another aspect, comment information related to the identification code from the computer embedded object of a second user is sent to the first user for display. The comment information comprises, for example, any or any combination of information about the usage experience of the first user, a log file of the computer embedded object, a tweet, is located in a fan page.

In another aspect, an identification code is derived from a hostname of the computer embedded object and an identity authenticating password. The identity authenticating password and the hostname of the computer embedded object is used for accessing the identification code stored in the computer embedded object.

In another aspect, a computer implemented method of sharing identification information relating to a computer embedded object of a plurality of users participating in a social networking service is disclosed. The method comprises receiving a list of identification codes of a group of computer embedded objects from a group of users of the social networking service. The method further includes grouping the list of identification codes according to an internet service provider and comparing a promotion carrier service to the internet service provider service and providing promotion information. Finally the method includes sending promotion information based on the grouping to the list of users for display

In yet another aspect, a computer implemented method of sharing an identification code of a computer embedded object of users participating in a social networking service is disclosed. The method comprises receiving a list of identification codes of a group of computer embedded objects from a group of users of the social networking service and grouping the list of the identification codes according to a service provider. The method includes comparing a promotion carrier service to the service provider service and sending promotion information of the promotion carrier service based on the grouping to the group of users for display.

### 3. Example Embodiments

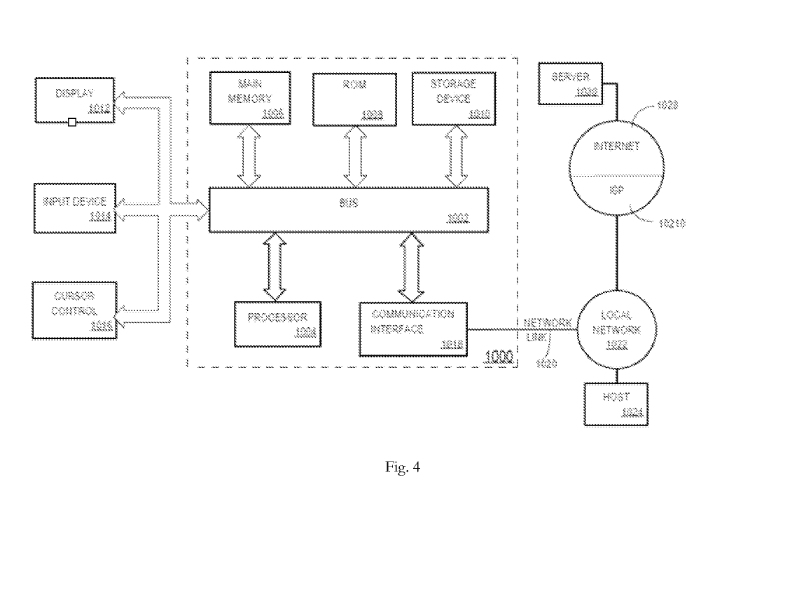

For example, FIG. 4 is a block diagram that illustrates a computer system 1000 upon which an embodiment of the invention may be implemented. Computer system 1000 includes a bus 1002 or other communication mechanism for communicating information, and a hardware processor 1004 coupled with bus 1002 for processing information. Hardware processor 1004 may be, for example, a general purpose microprocessor.

Computer system 1000 also includes a main memory 1006, such as a random access memory (RAM) or other dynamic storage device, coupled to bus 1002 for storing information and instructions to be executed by processor 1004. Main memory 1006 also may be used for storing temporary variables or other intermediate information during execution of instructions to be executed by processor 1004. Such instructions, when stored in non-transitory storage media accessible to processor 1004, render computer system 1000 into a special-purpose machine that is customized to perform the operations specified in the instructions.

Computer system 1000 further includes a read only memory (ROM) 1008 or other static storage device coupled to bus 1002 for storing static information and instructions for processor 1004. A storage device 1010, such as a magnetic disk or optical disk, is provided and coupled to bus 1002 for storing information and instructions.

Computer system 1000 may be coupled via bus 1002 to a display 1012, such as a cathode ray tube (CRT), for displaying information to a computer user. An input device 1014, including alphanumeric and other keys, is coupled to bus 1002 for communicating information and command selections to processor 1004. Another type of user input device is cursor control 1016, such as a mouse, a trackball, or cursor direction keys for communicating direction information and command selections to processor 1004 and for controlling cursor movement on display 1012. This input device typically has two degrees of freedom in two axes, a first axis (e.g., x) and a second axis (e.g., y), that allows the device to specify positions in a plane.

Computer system 1000 may implement the techniques described herein using customized hard-wired logic, one or more ASICs or FPGAs, firmware and/or program logic which in combination with the computer system causes or programs computer system 1000 to be a special-purpose machine. According to one embodiment, the techniques herein are performed by computer system 1000 in response to processor 1004 executing one or more sequences of one or more instructions contained in main memory 1006. Such instructions may be read into main memory 1006 from another storage medium, such as storage device 1010. Execution of the sequences of instructions contained in main memory 1006 causes processor 1004 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 1010. Volatile media includes dynamic memory, such as main memory 1006. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, or any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1002. Transmission media can also take the form of acoustic or light waves, such as those generated during radio-wave and infra-red data communications.

Various forms of media may be involved in carrying one or more sequences of one or more instructions to processor 1004 for execution. For example, the instructions may initially be carried on a magnetic disk or solid state drive of a remote computer. The remote computer can load the instructions into its dynamic memory and send the instructions over a telephone line using a modem. A modem local to computer system 1000 can receive the data on the telephone line and use an infra-red transmitter to convert the data to an infra-red signal. An infra-red detector can receive the data carried in the infra-red signal and appropriate circuitry can place the data on bus 1002. Bus 1002 carries the data to main memory 1006, from which processor 1004 retrieves and executes the instructions. The instructions received by main memory 1006 may optionally be stored on storage device 1010 either before or after execution by processor 1004.

Computer system 1000 also includes a communication interface 1018 coupled to bus 1002. Communication interface 1018 provides a two-way data communication coupling to a network link 1020 that is connected to a local network 1022. For example, communication interface 1018 may be an integrated services digital network (ISDN) card, cable modem, satellite modem, or a modem to provide a data communication connection to a corresponding type of telephone line. As another example, communication interface 1018 may be a local area network (LAN) card to provide a data communication connection to a compatible LAN. Wireless links may also be implemented. In any such implementation, communication interface 1018 sends and receives electrical, electromagnetic or optical signals that carry digital data streams representing various types of information.

Network link 1020 typically provides data communication through one or more networks to other data devices. For example, network link 1020 may provide a connection through local network 1022 to a host computer 1024 or to data equipment operated by an Internet Service Provider (ISP) 1026. ISP 1026 in turn provides data communication services through the world wide packet data communication network now commonly referred to as the “Internet” 1028. Local network 1022 and Internet 1028 both use electrical, electromagnetic or optical signals that carry digital data streams. The signals through the various networks and the signals on network link 1020 and through communication interface 1018, which carry the digital data to and from computer system 1000, are for example forms of transmission media.

Computer system 1000 can send messages and receive data, including program code, through the network(s), network link 1020 and communication interface 1018. In the Internet example, a server 1030 might transmit a requested code for an application program through Internet 1028, ISP 1026, local network 1022 and communication interface 1018.

The received code may be executed by processor 1004 as it is received, and/or stored in storage device 1010, or other non-volatile storage for later execution.

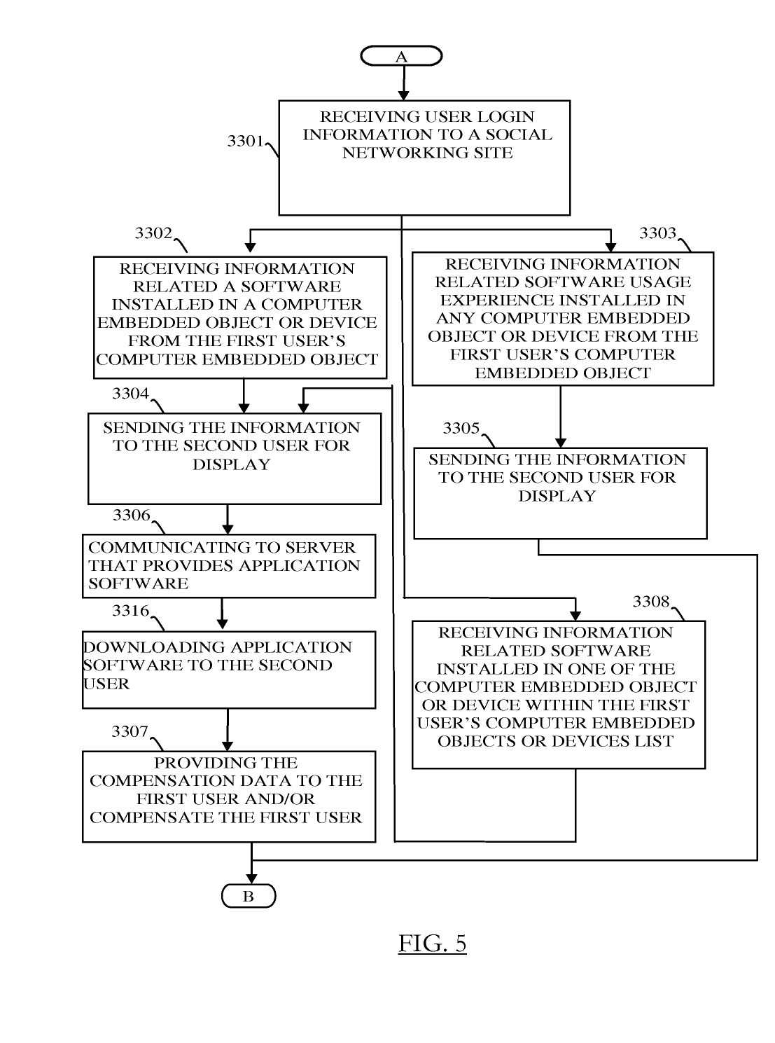

FIG. 5 illustrates a flow chart for sharing information between users participating in a social networking in accordance with the present invention. First, user login information to a social networking site is received by a first user, via step 3301. Next, information related to software installed in a computer embedded object or device from the first user's computer embedded object is received, via step 3302. Thereafter, information is sent to the second user for display, via step 3304. Next there is a communication to a server that provides application software downloadable from a second server and the second user downloads the software, via step 3306 and step 3316. Thereafter, compensation data is provided to the first user and/or the first user is compensated, via step 3307. In another embodiment, after step 3301, the information related software usage experience installed in any computer embedded object or device from the first user's computer embedded object is received, via step 3303. Next the information is sent to the second user for display, via step 3305. Yet in another embodiment, after step 3301, the information related software installed in one of the computer embedded object or device within the first user's computer embedded objects or devices list is received, via step 3308.

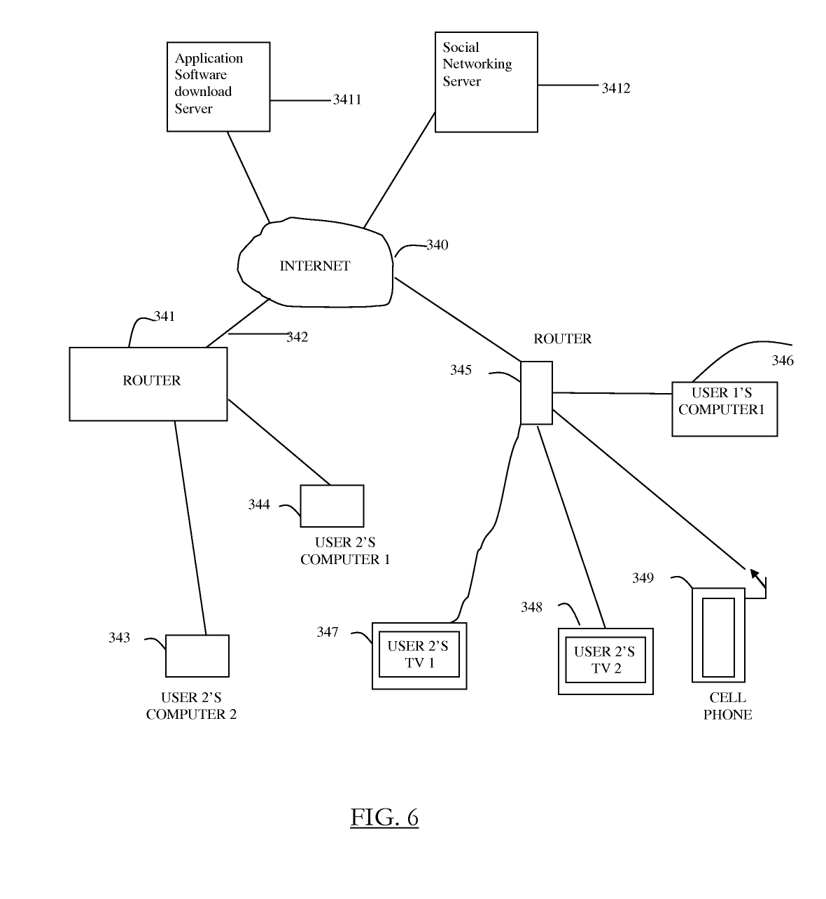

FIG. 6 illustrates a social networking environment in accordance with the present invention would be utilized. In this environment an Application Software Download Server 3411 and a Social Networking Server 3412 is coupled to the Internet 340. A Router 341 is also coupled to the Internet 340. The Router 341 is also connected to user 1 computer 343 and the user 2 computer 344. A second router 345 is also connected to the Internet 340. The second router 345 is connected to a computer 346, a first TV 347, a second TV 348, and a Cell Phone 349.

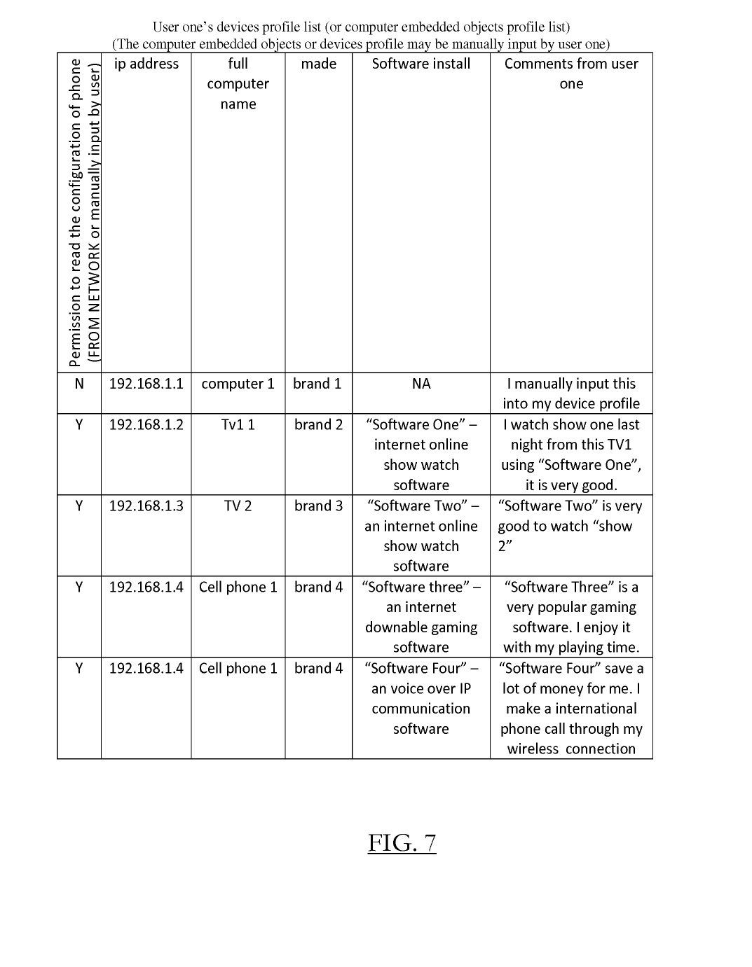

FIG. 7 illustrates an example of a user devices or objects profile list. The computer embedded objects or devices profile may be manually input by a user. Permission to read the configuration of phone can be provided from the network or can be manually input by the user. As is seen user comments can be made for each device that the user owns.

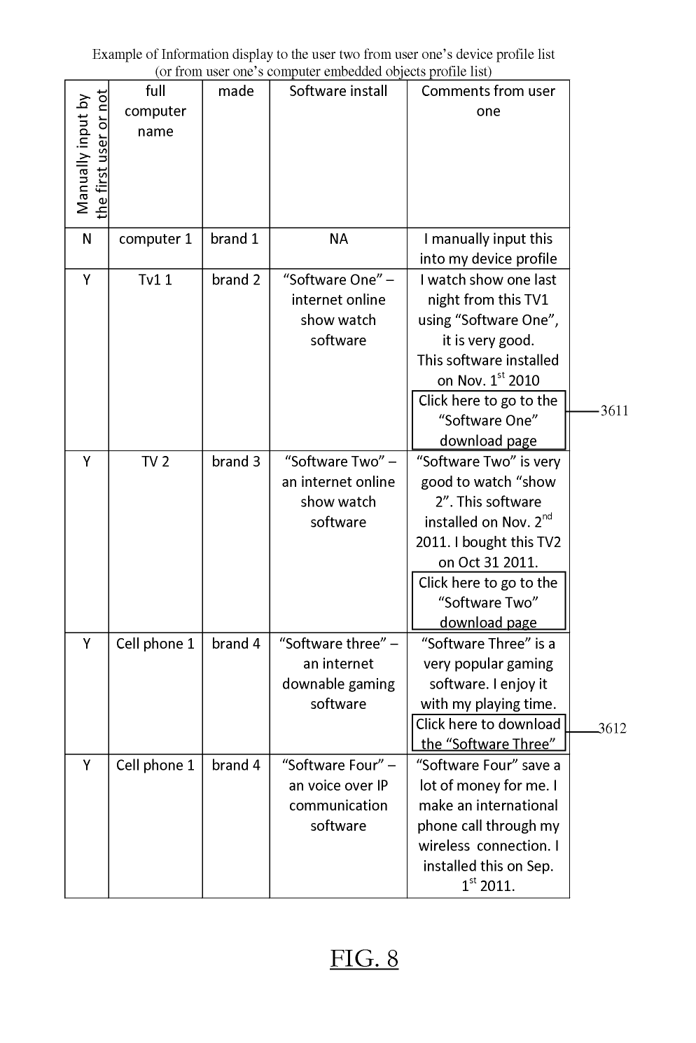

FIG. 8 is an example of Information Display to the user two from user one's device profile list or from user one's computer embedded objects profile list. This information could be manually input by the first user or not.

### 4. More Examples of Possible Embodiments

In a possible embodiment, a user profile might consist of information related to a user, which might include but not be limited to user's age, sex, occupation, name, email address, phone number, computer model or computer identification code or computer specification that is owned or used by the user. In a possible embodiment, a device list profile might consist of a list of the devices that are owned or used by the user. The list of the device or object might include but are not limited to the identification code, specification, usage, service history, network login history of a computer embedded device or object. The device or object list might have a categories that consists of, but is not limited to, home devices list category, work device list category, mobile device list category. The content of the user profile might be able to be collected by the user via computer network connection. In a possible embodiment, user1 might install an application software ABC into user1's cell phone 349 (refer to FIG. 6) and an application software DEF into user1's TV1 347 (refer to FIG. 6). The application software DEF and application software ABC, while running, may be able to communicate and transfer identification code, specifications or a list of installed application software of TV1 to user1's cell phone 349. The user1's cell phone may save the transferred information, the identification code of TV1 or specifications of TV1 or a list of the installed application software of TV1, as part of the user profile or as part of user's device list profile. The “communication and transfer” between application software DEF and application software ABC may be implemented, but not limited to, by one of the following exemplary methods: peer to peer network communication (direct network communication between user1's cell phone and user1's TV, such as Near Field Communication), communication through a 3^{rd} party server (communication through one or more server computer over the internet that aids the data transfer, such as BUMP. www.bu.mp In the cased of using Bump, the application software DEF and/or the application software ABC may use Bump's Application Program Interface (API)). The “communication and transfer” between application software DEF and application software ABC may be implemented, but not limited to, by one of the following exemplary data transfer methods: the data queried by application software ABC and received by application software ABC, the data broadcasted by application software DEF and received by application software ABC.

In a possible embodiment, a server might suggest software to be installed to a user's device based on the software installed in each of the device. Such a suggestion might be in form of advertisement.

In one possible embodiment, a system may deliver information, wherein the information derived from a device list profile of a first user, which the device list may consist of at least one of the computer embedded objects that may be collected by the first user from a computer network or from a first user computer, or manually entered by the first user, or by the first user's purchasing history, or billing history of the first user, or first user device internet search history, or first user's internet browsing history of computer devices or first user's device activity history (includes any of, but not limited to, device power on and off history, login history, download history, battery charging history, bandwidth usage history, memory usage history, email history, user blog history, computer embedded object power consumption history). The information about an object may be delivered to the second user by the system that may be inferred or extrapolated preference of the first user based on the device list profiles of the first user or explicitly asking the second user for preferences based on the first user's device list profile.

In a example embodiment, a computer implemented method or a computer-readable medium of sharing information between a plurality of users participating in a social networking service, each of the plurality of users having a computer embedded object, the method executed by a computer system, the method comprising: receiving information, by a server, relating to the computer embedded object of a first user of the plurality of users; and sending, at the server, the information of the computer embedded object to a second user for display.

Optionally, in an example embodiment, a method or computer-readable medium further comprises wherein the information related to software installed in the first computer embedded object.

Optionally, in an example embodiment, a method or computer-readable medium further comprises wherein the information comprise the comment information relating to a software installed in the computer embedded object of the first user from the computer embedded object of the first user.

Optionally, in an example embodiment, a method or computer-readable medium further comprises wherein the information related to a software comprises any and any combination of: usage experience, user rating, editor rating, total downloads, downloads, version, released date, date of the first installation, date of the software installation history, installation history, and purchase price.

Optionally, in an example embodiment, a method or computer-readable medium further comprises wherein the information is the first user's comment.

Optionally, in an example embodiment, a method or computer-readable medium further comprises facilitating communication, at the server, between the computer embedded object of the second user and an application software server to provide an application downloadable by the computer embedded object of the second user, the application software corresponding to the information relating to the computer embedded object of a first user of the plurality of users; detecting, by at least one processor, an execution of the application software by the computer embedded object of the second user; and associating compensation data with the computer embedded object and an account associated with a first user of the computer embedded object for an installation of the application software on the computer embedded object of the second user.

Optionally, in an example embodiment, a method or computer-readable medium further comprises deriving compensation data, at the server, for the first user from the information sent.

Optionally, in an example embodiment, a method or computer-readable medium further comprises wherein associating compensation data, at the server, with the computer embedded object and an account associated with a first user of the computer embedded object for an installation of the application software on the computer embedded object of the second user.

Optionally, in an example embodiment, a method or computer-readable medium further comprises wherein the compensation data may be derived by any of the following compensation models: pay-per-click, pay-per-impression, pay-per-install.

Optionally, in an example embodiment, a method or computer-readable medium further comprises wherein the computer embedded object of a first user of the plurality of users may be described within a list of the computer embedded objects of a first user of the plurality of users.

Optionally, in an example embodiment, a method or computer-readable medium further comprises wherein the information further comprises information related to software installed in the at least one computer embedded object of the first user.

Optionally, in an example embodiment, a method or computer-readable medium further comprises wherein the information further comprises the list of computer embedded object of a first user is stored in first user's profile associated with first user's social networking account.

Optionally, in an example embodiment, a method or computer-readable medium further comprises wherein the information comprise the comment information relating to a software installed in one of the computer embedded object of the first user's computer embedded object list.

Optionally, in an example embodiment, a method or computer-readable medium further comprises wherein the information related to a software comprises any and any combination of usage experience, user rating, editor rating, total downloads, downloads, version, released date, date of the first installation, date of the software installation history, installation history, and purchase price.

Optionally, in an example embodiment, a method or computer-readable medium further comprises wherein the information consist of the first user's comment.

Optionally, in an example embodiment, a method or computer-readable medium further comprises: facilitating communication, at the server, between the computer embedded object of the second user and an application software server to provide an application downloadable to be installed in the computer embedded object of the second user, the application software corresponding to the information relating to the computer embedded object of a first user of the plurality of users; detecting, by the server, an execution of the application software by the computer embedded object of the second user; and associating compensation data with the computer embedded object and an account associated with a first user of the computer embedded object for a installation of the application software on the computer embedded object of the second user.

Optionally, in an example embodiment, a method or computer-readable medium further comprises: deriving compensation data, by the server, for the first user from the information sent.

Optionally, in an example embodiment, a method or computer-readable medium further comprises wherein the compensation data may be derived by any of the following compensation models: pay-per-click, pay-per-impression, pay-per-install.

Optionally, in an example embodiment, a method or computer-readable medium further comprises: detecting, by the server, the software installed in the computer embedded object of a first user of the plurality of users.

Optionally, in an example embodiment, a method or computer-readable medium further comprises wherein the information of the computer embedded object to a second user for display is the detected software information.

In an embodiment, an apparatus for sharing information between a plurality of users participating in a social networking service, each of the plurality of users having a computer embedded object, which when executed by one or more processors, cause performing steps of: in response to receiving input from a first user at a first user computer embedded object, a device, at a server, that receives information relating to the first computer embedded object of the first user of the plurality of users; and a device, at a server, that sends the information of the first user computer embedded object to a second user for display.

Optionally, in an example embodiment, an apparatus further comprises wherein the information further comprises information related to software installed in the first computer embedded object.

Optionally, in an example embodiment, an apparatus further comprises wherein the information comprise the comment information relating to a software installed in the computer embedded object of the first user from the computer embedded object of the first user.

Optionally, in an example embodiment, an apparatus further comprises wherein the information related to a software comprises any and any combination of: usage experience, user rating, editor rating, total downloads, downloads, version, released date, date of the first installation, date of the software installation history, installation history, and purchase price.

Optionally, in an example embodiment, an apparatus further comprising wherein the information may be the first user's comment.

Optionally, in an example embodiment, an apparatus further comprising: a device, at a server, that facilitates communication between the computer embedded object of the second user and an application software server to provide an application downloadable by the computer embedded object of the second user, the application software corresponding to the information relating to the computer embedded object of a first user of the plurality of users; a device, at a server, that detects, by at least one processor, an execution of the application software by the computer embedded object of the second user; and associating compensation data with the computer embedded object and an account associated with a first user of the computer embedded object for an installation of the application software on the computer embedded object of the second user.

Optionally, in an example embodiment, an apparatus further comprising: a device, at a server, that derives compensation data for the first user from the information sent.

Optionally, in an example embodiment, an apparatus further comprising: a device, at a server, that associates compensation data with the computer embedded object and an account associated with a first user of the computer embedded object for an installation of the application software on the computer embedded object of the second user.

Optionally, in an example embodiment, an apparatus further comprises wherein the compensation data is derived by any of the following compensation models: pay-per-click, pay-per-impression, pay-per-install.

Optionally, in an example embodiment, an apparatus further comprises wherein the computer embedded object of a first user of the plurality of users is within a list of the computer embedded objects of a first user of the plurality of users.

Optionally, in an example embodiment, an apparatus further comprises wherein the information further comprises information related to software installed in the at least one computer embedded object of the first user.

Optionally, in an example embodiment, an apparatus further comprises wherein the information further comprises the list of computer embedded object of a first user is stored in first user's profile associated with first user's social networking account.

Optionally, in an example embodiment, an apparatus further comprises wherein the information comprise the comment information relating to a software installed in one of the computer embedded object of the first user's computer embedded object list.

Optionally, in an example embodiment, an apparatus further comprises wherein the information related to a software comprises any and any combination of usage experience, user rating, editor rating, total downloads, downloads, version, released date, date of the first installation, date of the software installation history, installation history, and purchase price.

Optionally, in an example embodiment, an apparatus further comprises wherein the information is the first user's comment.

Optionally, in an example embodiment, an apparatus further comprising: a device, at a server, that facilitates communication between the computer embedded object of the second user and an application software server to provide an application downloadable by the computer embedded object of the second user, the application software corresponding to the information relating to the computer embedded object of a first user of the plurality of users; a device, at a server, that detects, by at least one processor, an execution of the application software by the computer embedded object of the second user; and associating compensation data with the computer embedded object and an account associated with a first user of the computer embedded object for a installation of the application software on the computer embedded object of the second user.

Optionally, in an example embodiment, an apparatus further comprising: a device, at a server, that derives compensation data for the first user from the information sent.

Optionally, in an example embodiment, an apparatus further comprises wherein the compensation data is derived by any of the following compensation models: pay-per-click, pay-per-impression, pay-per-install.

Optionally, in an example embodiment, an apparatus further comprising: a device, at a server, that detects, by at least one processor, the software installed in the computer embedded object of a first user of the plurality of users.

Optionally, in an example embodiment, an apparatus further comprises wherein the information of the computer embedded object to a second user for display is the detected software information.

In a example embodiment, a computer implemented method or a computer-readable medium of sharing information between a plurality of users participating in a social networking service, each of the plurality of users having a first computer embedded object, the method executed by a computer system, the method comprising: receiving information, at a server, relating to the first computer embedded object of a first user of the plurality of users; sending the information or portion of the information, by the server, of the first computer embedded object of the first user to a second user for display; facilitating communication, by the server, between the first computer embedded object of the second user and an application software server to provide an application software downloadable to the first computer embedded object of the second user, the application software corresponding to the information relating to the first computer embedded object of the first user of the plurality of users.

Optionally, in an example embodiment, a method or computer-readable medium further comprises: detecting, by the server, an installation of the application software in the first computer embedded object of the second user; deriving, by the server, compensation data for the first user based on the installation of the application software.

Optionally, in an example embodiment, a method or computer-readable medium further comprises: wherein the information related to a software installed in the first computer embedded object of the first user comprises any and any combination of: usage experience, user rating, editor rating, total downloads, downloads, version, released date, date of the first installation, date of the software installation history, installation history, the first user's comments, and purchase price; and wherein the compensation data is derived by any of the following compensation models: pay-per-click, pay-per-impression, pay-per-install.

Optionally, in an example embodiment, a method or computer-readable medium further comprises: wherein the receiving information relating to the first computer embedded object of a first user of the plurality of users may be received through a second computer embedded object of the first user.

Optionally, in an example embodiment, a method or computer-readable medium further comprises: wherein the computer embedded object of a first user of the plurality of users is within a list of the computer embedded objects of a first user of the plurality of users.

In an embodiment, an apparatus for sharing information between a plurality of users participating in a social networking service, each of the plurality of users having a computer embedded object, which when executed by one or more processors, cause performing steps of: a device, at a server, that receives information relating to the first computer embedded object of a first user of the plurality of users; a device, at a server, that sends the information or portion of the information of the first computer embedded object of the first user to a second user for display; a device, at a server, that facilitates communication between the first computer embedded object of the second user and an application software server to provide an application software downloadable to the first computer embedded object of the second user, the application software corresponding to the information relating to the first computer embedded object of the first user of the plurality of users.

Optionally, in an example embodiment, an apparatus further comprises: a device, at a server, that detects an installation of the application software by the first computer embedded object of the second user; and a device, at a server, that derives compensation data for the first user based on the installation of the application software.

Optionally, in an example embodiment, an apparatus further comprises: wherein the information related to a software installed in the first computer embedded object of the first user comprises any and any combination of: usage experience, user rating, editor rating, total downloads, downloads, version, released date, date of the first installation, date of the software installation history, installation history, the first user's comments, and purchase price; and wherein the compensation data is derived by any of the following compensation models: pay-per-click, pay-per-impression, pay-per-install.

Optionally, in an example embodiment, an apparatus further comprises: wherein the receiving information relating to the first computer embedded object of a first user of the plurality of users may be received through a second computer embedded object of the first user.

Optionally, in an example embodiment, an apparatus further comprises: wherein the computer embedded object of a first user of the plurality of users is within a list of the computer embedded objects of a first user of the plurality of users.

In a example embodiment, a computer implemented method or a computer-readable medium of sharing computer embedded object information between a plurality of users participating in a social networking service, each of the plurality of users having at least one computer embedded object, the method executed by a computer system, the method comprising: receiving information, at a server, relating to a software installed in the first computer embedded object of a first user; sending the information or portion of the information, by the server, of the first computer embedded object of the first user to a first computer embedded object of a second user for display; facilitating communication, by the server, between the first computer embedded object of the second user and an application software server for the application software server to provide an application software downloadable to the first computer embedded object of the second user, wherein the application software downloadable derived from the information or portion of the information.

Optionally, in an example embodiment, a method or computer-readable medium further comprises: detecting, by the server, an installation of the application software in the first computer embedded object of the second user; deriving, by the server, compensation data for the first user based on the installation of the application software.

Optionally, in an example embodiment, a method or computer-readable medium further comprises: wherein the information related to a software installed in the first computer embedded object of a first user includes any and any combination of: usage experience, user rating, editor rating, total downloads, downloads, version, released date, date of the first installation, date of the software installation history, installation history, the first user's comments, and purchase price; and wherein the compensation data is derived by any of the following compensation models: pay-per-click, pay-per-impression, pay-per-install.

Optionally, in an example embodiment, a method or computer-readable medium further comprises: wherein the receiving information relating to the first computer embedded object of a first user may be received through a second computer embedded object of the first user.

Optionally, in an example embodiment, a method or computer-readable medium further comprising: adding, by the server, the information relating to a software installed in the first computer embedded object of a first user into a device list, wherein the device list include a list of identification codes of the computer embedded objects.

In an embodiment, an apparatus for sharing computer embedded object information between a plurality of users participating in a social networking service, each of the plurality of users having a computer embedded object, which when executed by one or more processors, cause performing steps of: a device, at a server, that receives information relating to a software installed in the first computer embedded object of a first user; a device, at a server, that sends the information or portion of the information of the first computer embedded object of the first user to a first computer embedded object of a second user for display; a device, at a server, that facilitates communication between the first computer embedded object of the second user and an application software server for the application software server to provide an application software downloadable to the first computer embedded object of the second user, wherein the application software downloadable derived from the information or portion of the information.

Optionally, in an example embodiment, an apparatus further comprises: detecting, at a server, an installation of the application software in the first computer embedded object of the second user; deriving, at a server, compensation data for the first user based on the installation of the application software.

Optionally, in an example embodiment, an apparatus further comprises wherein the information related to a software installed in the first computer embedded object of a first user includes any and any combination of: usage experience, user rating, editor rating, total downloads, downloads, version, released date, date of the first installation, date of the software installation history, installation history, the first user's comments, and purchase price; and wherein the compensation data is derived by any of the following compensation models: pay-per-click, pay-per-impression, pay-per-install.

Optionally, in an example embodiment, an apparatus further comprises wherein the receiving information relating to the first computer embedded object of a first user may be received through a second computer embedded object of the first user.

Optionally, in an example embodiment, an apparatus further comprising: a device, at the server, that adds the information relating to a software installed in the first computer embedded object of a first user into a device list, wherein the device list include a list of identification codes of the computer embedded objects.

In a example embodiment, a computer implemented method or a computer-readable medium of sharing computer embedded object information between a plurality of users participating in a social networking service, each of the plurality of users having at least one computer embedded object, the method executed by a computer system, the method comprising steps of: in response to receiving input from a first user at a first user computer embedded object, receiving information of the first computer embedded object; receiving, by the first user computer embedded object, a first comment from the first user related to the first computer embedded object of the first user; sending, by the first user computer embedded object, the first comment to a server; receiving, by the user computer embedded object, information of a second computer embedded object of the first user from the second computer embedded object through a data communication network; combining, by the user computer embedded object, the information of the first computer embedded object and the information of the second computer embedded object to a list of the information of the computer embedded objects; sending, by the user computer embedded object, the list of the information of the computer embedded objects to the server; receiving, by the user computer embedded object, at least one comment from a second user related to one of the computer embedded objects in the list.

In an embodiment, an apparatus for sharing computer embedded object information between a plurality of users participating in a social networking service, each of the plurality of users having a computer embedded object, which when executed by one or more processors, cause performing steps of: a device, at a first user computer embedded object, that, in response to receiving input from a first user, receives information of the computer embedded object; a device, at the first user computer embedded object, that receives a first comment from the first user related to the first computer embedded object of the first user; a device, at the first user computer embedded object, that sends the first comment or the information or portion of the information to a server; a device, a the first user computer embedded object, that receives information of a second computer embedded object of the first user from the second computer embedded object through a data communication network; a device, at the first user computer embedded object, that combines the information of the first computer embedded object and the information of the second computer embedded object to a list of the information of the computer embedded objects; a device, at the first user computer embedded object, that sends the list of the information of the computer embedded objects to the server; a device, at the first user computer embedded object, that receives at least one comment from a second user related to one of the computer embedded objects in the list.

In a example embodiment, a computer implemented method or a computer-readable medium of sharing computer embedded object information between a plurality of users participating in a social networking service, each of the plurality of users having at least one computer embedded object, the method executed by a computer system, the method comprising steps of: in response to receiving input from a first user at a first user computer embedded object, receiving information related to a software installed in a first computer embedded object of the first user; receiving, by the first user computer embedded object, a first comment from the first user related to the software installed in the first computer embedded object of the first user; sending, by the first user computer embedded object, the first comment or the information related to a software installed in the first computer embedded object of the first user to a server; receiving, by the first user computer embedded object, compensation data for the first user, wherein the compensation data derived from an application software downloadable installed in a first computer embedded object of a second user, and wherein the application software downloadable derived from the first comment or the information related to a software installed in the first computer embedded object of the first user.

In an embodiment, an apparatus for sharing computer embedded object information between a plurality of users participating in a social networking service, each of the plurality of users having a computer embedded object, which when executed by one or more processors, cause performing steps of: a device, at the first user computer embedded object, that, in response to receiving input from a first user, receives information related to a software installed in a first computer embedded object of the first user; a device, at the first user computer embedded object, that, receives a first comment from the first user related to the software installed in the first computer embedded object of the first user; a device, at the first user computer embedded object, that sends the first comment or the information related to a software installed in the first computer embedded object of the first user to a server; a device, at the first user computer embedded object, that receives compensation data, derived from an application software downloadable installed in a first computer embedded object of a second user, for the first user, wherein the application software downloadable derived from the first comment or the information related to a software installed in the first computer embedded object of the first user.

### 5. Equivalents, Extensions, Alternatives and Miscellaneous

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A computer implemented method of sharing computer embedded object information between a plurality of users participating in a social networking service, each of the plurality of users having at least one computer embedded object, the method executed by a computer system, the method comprising:
receiving information, at a server, relating to a software installed in the first computer embedded object of a first user;
sending the information or portion of the information, by the server, of the first computer embedded object of the first user to a first computer embedded object of a second user for display;
facilitating communication, by the server, between the first computer embedded object of the second user and an application software server for the application software server to provide an application software downloadable to the first computer embedded object of the second user, wherein the application software downloadable derived from the information or portion of the information;
detecting, by the server, an installation of the application software in the first computer embedded object of the second user;
deriving, by the server, compensation data for the first user based on the installation of the application software.

2. The method of claim 1, wherein the information related to a software installed in the first computer embedded object of a first user includes any and any combination of: usage experience, user rating, editor rating, total downloads, downloads, version, released date, date of the first installation, date of the software installation history, installation history, the first user's comments, and purchase price; and wherein the compensation data is derived by any of the following compensation models: pay-per-click, pay-per-impression, pay-per-install.

3. The method of claim 1, wherein the receiving information relating to the first computer embedded object of a first user may be received through a second computer embedded object of the first user.

4. The method of claim 1, further comprising: adding, by the server, the information relating to a software installed in the first computer embedded object of a first user into a device list, wherein the device list include a list of identification codes of the computer embedded objects.

5. A computer implemented method of sharing computer embedded object information between a plurality of users participating in a social networking service, each of the plurality of users having at least one user computer, the method comprising steps of:
in response to receiving input from a first user at a first user computer embedded object, receiving information of the first computer embedded object;
receiving, by the first user computer embedded object, a first comment from the first user related to the first computer embedded object of the first user;
sending, by the first user computer embedded object, the first comment to a server;
receiving, by the user computer embedded object, information of a second computer embedded object of the first user from the second computer embedded object through a data communication network;
combining, by the user computer embedded object, the information of the first computer embedded object and the information of the second computer embedded object to a list of the information of the computer embedded objects;
sending, by the user computer embedded object, the list of the information of the computer embedded objects to the server;
receiving, by the user computer embedded object, at least one comment from a second user related to one of the computer embedded objects in the list.

6. A computer implemented method of sharing information between a plurality of users participating in a social networking service, each of the plurality of users having at least one user computer, the method comprising steps of:
in response to receiving input from a first user at a first user computer embedded object, receiving information related to a software installed in a first computer embedded object of the first user;
receiving, by the first user computer embedded object, a first comment from the first user related to the software installed in the first computer embedded object of the first user;
sending, by the first user computer embedded object, the first comment or the information related to a software installed in the first computer embedded object of the first user to a server;
receiving, by the first user computer embedded object, compensation data for the first user, wherein the compensation data derived from an application software downloadable installed in a first computer embedded object of a second user, and wherein the application software downloadable derived from the first comment or the information related to a software installed in the first computer embedded object of the first user.

7. The method of claim 6, wherein the first user computer embedded object of the first user may be any of, but not limited to, the following devices: smart phone, ebook, mobile device, computer tablet.

8. The method of claim 5, wherein the sharing computer embedded object information may consist of, but not limited to, the following information that is located in a computer embedded object of a user: purchasing history, billing history, internet search history, internet browsing history, power on and off of the computer embedded object, login history of the computer embedded object, software download history of the computer embedded object, battery charging history of the computer embedded object, bandwidth usage history, memory usage history, email history, user blog history, computer embedded object power consumption history.
